(19) United States
(12) Patent Application Publication
(10) Pub. No.: US 2026/0257931 A1
(43) Pub. Date: Sep. 3, 2026

(54) PROCESS FOR RECOVERY OF LITHIUM FROM BRINE

(71) Applicant: Aquatech International, LLC, Canonsburg, PA (US)

(72) Inventor: Craig Johnstone Brown, Pickering (CA)

(73) Assignee: Aquatech International, LLC, Canonsburg, PA (US)

(21) Appl. No.: 18/872,836

(22) PCT Filed: May 18, 2023
(86) PCT No.: PCT/IB2023/055116

§ 371 Date: Dec. 9, 2024

Related U.S. Application Data
(60) Provisional application No. 63/355,164, filed on Jun. 24, 2022.

(51) Int. Cl. C01D 15/04; B01D 9/00; B01D 15/36; B01D 15/42; B01D 61/02; B01D 61/04; B01J 20/06; B01J 20/08; B01J 39/05; B01J 39/18; C01D 3/06

(52) U.S. Cl. CPC C01D 15/04; B01D 9/0018; B01D 15/362; B01D 15/426; B01D 61/025; B01D 61/04; B01J 20/06; B01J 20/08; B01J 39/05; B01J 39/18; C01D 3/06

(57) ABSTRACT

A process of recovering lithium from a brine containing lithium. The process comprises: providing the brine to a lithium-selective sorbent for adsorbing the lithium to the lithium-selective sorbent; eluting the lithium from the lithium-selective sorbent to form an eluate containing the lithium and multi-valent ions; exchanging the multi-valent ions in the eluate for monovalent ions to form a softened lithium solution; and crystallizing the monovalent ions to form a crystallized product and a concentrated lithium product.

### RELATED REFERENCES

This application claims priority to U.S. Provisional Patent Application No. 63/355,164 filed on Jun. 24, 2022, which is incorporated herein by reference in its entirety.

### BACKGROUND

Largely as a result of the recent interest in the use of lithium-ion batteries for electric vehicles, the demand for lithium has increased substantially and may soon outstrip supply. There is potentially a large supply of lithium available in various brines such as seawater, geothermal brines, produced water, and salt lakes. Recently, there has also been interest in extracting lithium from clays using chloride-based lixiviants, resulting in the production of similar lithium containing brines. The concentration of lithium in these brines is usually too low to allow recovery by conventional means such as solar evaporation and crystallization.

A number of processes are currently under development to extract lithium directly from brine. Such processes are called direct lithium extraction (“DLE”). In the DLE process, the lithium is extracted from the brine by contacting the brine with a sorbent. The lithium is then eluted from the sorbent with an eluant to produce an eluate which may be at a similar or somewhat higher lithium concentration and lower impurity level than the original brine. DLE can be conducted with the sorbent in a variety of configurations.

A useful feature of the DLE processes is that they can extract the lithium from the brine, even where it exists in low concentrations, while minimizing the co-extraction of other impurity ions such as sodium, potassium, calcium, and magnesium, which typically exist in concentrations far exceeding that of the lithium. While many of these DLE processes are indeed very selective for lithium, the recovered lithium eluate solution from DLE may still contain low but objectionable impurity levels.

Some DLE processes have the capability of eluting the lithium from the sorbent at a higher concentration than in the original source brine. For example, if the lithium concentration in the source brine is 200 mg/L, the lithium concentration in the eluate may be on the order of a few grams per liter. This degree of concentration is generally not sufficient however and further concentration is required. In addition, certain existing methods of extracting lithium from brine tend to also collect sufficient impurities such that further purification is required.

As a result, a need continues to exist for an improved process for recovering lithium from a brine.

### SUMMARY

In accordance with one embodiment of the disclosure, a process of recovering lithium from a brine containing lithium. The process comprises: providing the brine to a lithium-selective sorbent for adsorbing the lithium to the lithium-selective sorbent; eluting the lithium from the lithium-selective sorbent to form an eluate containing the lithium and multi-valent ions; exchanging the multi-valent ions in the eluate for monovalent ions to form a softened lithium solution; and crystallizing the monovalent ions to form a crystallized product and a concentrated lithium product.

Other features and aspects of the disclosure are set forth in greater detail below.

### BRIEF DESCRIPTION OF THE DRAWINGS

The disclosure will now be described, by way of example, with reference to the accompanying drawings, in which:

FIG. 1 illustrates an embodiment of a process for direct lithium extraction;

FIG. 2 illustrates the solubility of NaCl as it is being concentrated based on a simulation;

FIG. 3 illustrates the concentration of lithium in the effluent as a function of volume based on Example 1; and

FIG. 4 illustrates an elution profile for the first elution step of

### DETAILED DESCRIPTION

It is to be understood by one of ordinary skill in the art that the present discussion is a description of exemplary embodiments only and is not intended as limiting the broader aspects of the disclosure.

Generally speaking, the disclosure is directed to a process of recovering lithium from a brine. In particular, the lithium may be a lithium halide. It has been discovered that the process as disclosed herein may provide multiple benefits compared to other DLE processes generally employed in the industry. For instance, without intending to be limited, it has been discovered that the process as disclosed herein may allow for the recovery of a lithium halide having a reduced concentration of impurities. Furthermore, the process as disclosed herein may be more economical, efficient, and environmentally friendly. For instance, liquid streams utilized in certain parts of the process may be utilized in other parts of the process in order to minimize the liquid, in particular water, consumption.

As indicated herein, the process is generally described based on a series of steps. However, it should be understood that some or all of such steps may be required in order to recover the lithium from the brine. In this regard, a combination of steps as disclosed herein may be used in various combinations in order to recover the lithium from the brine.

In general, the process as disclosed herein may include a step of providing a brine containing lithium. The source of the brine is not necessarily limited by the disclosure. For instance, the brine may include seawater, a geothermal brine, produced water, a salt lake, etc. The brine may also include one obtained from a lithium extraction from a clay. The lithium may be in the brine as an ion. In this regard, the brine may be a lithium solution.

In one embodiment, the process may include a step of pre-treating the brine. For instance, the pre-treatment may be conducted using various means for various reasons. In one embodiment, the pre-treatment may be a mechanical pre-treatment. For instance, the pre-treatment may simply be for the removal of solids within the brine. The means for removal such solids is not necessarily limited by the disclosure. For instance, such pre-treatment may include filtration. The filtration may include multi-media depth filtration, membrane micro-filtration, as well as other methods generally utilized in the art. If necessary in one embodiment, the pre-treatment may include a pH adjustment. For instance, the pH adjustment may be provided by using a pH buffer. In this regard, the pH buffer is not necessarily limited by the disclosure and may be one generally utilized in the art for adjusting pH. These may include a mixture of a weak acid and its conjugate base or a mixture of a weak base and its conjugate acid. The pre-treatment may be to concentrate the brine. Such concentration may be using means generally known in the art, such as evaporation. The pre-treatment may be to remove certain impurities present in the brine, such as those that may affect the purity of the final lithium product. These impurities may include multi-valent ions, such as divalent ions. Such pre-treatment may include a step of neutralization, such as with an alkali or ammonia.

The brine containing lithium may be provided to a lithium-selective sorbent. The lithium-selective sorbent may be presented in various forms that allows for selection or adsorption of the lithium to the sorbent. For instance, the lithium-selective sorbent may be presented in the form of a bed in one embodiment. The bed may be a fixed bed or a moving bed. In one embodiment, the bed may be a fixed bed. In another embodiment, the bed may be a moving bed. For instance, the moving bed may be a simulated moving bed. In addition, the bed may be operated in a co-current mode or a counter-current mode. In one embodiment, the bed may be operated in a co-current mode. In another embodiment, the bed may be operated in a counter-current mode.

The lithium-selective sorbent may be one that is generally known in the art. For instance, the lithium-selective sorbent may be an oxide of titanium, an oxide of niobium, an alumina, or a combination thereof. For instance, in one embodiment, the lithium-selective sorbent may be an oxide of titanium, such as metatitanic acid. In another embodiment, the lithium-selective sorbent may be an oxide of niobium, such as lithium niobate. In a further embodiment, the lithium-selective sorbent may be an alumina, in particular a hydrated alumina such as a polycrystalline hydrated alumina. The alumina may be intercalated with a lithium salt. For instance, the lithium salt may have the formula LiX wherein X is a halide. The halide may be fluoride, chloride, bromide, or iodide. In one embodiment, the halide may be fluoride. In another embodiment, the halide may be chloride. In a further embodiment, the halide may be bromide. In an even further embodiment, the halide may be iodide.

The lithium-selective sorbent can allow for the extraction or recovery of a relatively high amount of lithium from the brine. For instance, the amount of lithium adsorbed from the brine may be 20 mol % or more, such as 30 mol % or more, such as 40 mol % or more, such as 50 mol % or more, such as 60 mol % or more, such as 70 mol % or more, such as 80 mol % or more, such as 90 mol % or more, such as 95 mol % or more based on the total amount of lithium present in the brine. It should be understood that such amount may be based on the total amount of lithium present in the brine that is provided to the lithium-selective sorbent. In this regard, the brine containing lithium may be converted to a barren brine. The barren brine may be returned to the source from which it was originally obtained.

Once the lithium has adsorbed to or been recovered by the lithium-selective sorbent, the lithium, such as the adsorbed lithium, may be eluted using various means and is not necessarily limited. For instance, the process may include a step of eluting the lithium-selective sorbent, for instance, the lithium-selective sorbent with the adsorbed lithium. The eluting may be conducted with a liquid. The liquid utilized may be dictated by the type of lithium-selective sorbent utilized. The liquid may comprise water. In one embodiment, the liquid may primarily include water. For instance, the water may be present in an amount of 95 wt. % or more, such as 98 wt. % or more, such as 99 wt. % or more, such as 100 wt. %.

In one embodiment, the liquid may include water in combination with an acid. For instance, the liquid may be a dilute acid (i.e., an acid mixed with water in an amount more than the acid itself). In this regard, in one embodiment, the liquid may include more water than acid on a weight basis. The acid may be hydrochloric acid or sulfuric acid. The concentration of acid may be less than 1 M, such as 0.5 M or less, such as 0.2 M or less, such as 0.1 M or less. The acid may have a pH of 1 or more, such as 1.5 or more, such as 2 or more, such as 2.5 or more. The pH may be 4 or less, such as 3.5 or less, such as 3 or less, such as 2.5 or less, such as 2 or less.

An average contact time of the adsorbed lithium in the lithium-selective sorbent with the liquid, such as the acid, for eluting may be 2 hours or less, such as 1.5 hours or less, such as 1 hour or less, such as 0.9 hours or less, such as 0.8 hours or less, such as 0.6 hours or less, such as 0.5 hours or less.

In this regard, the eluting may result in an eluate containing lithium, in particular a lithium halide. For instance, the halide may be fluoride, chloride, bromide, or iodide. In one embodiment, the halide may be fluoride. In another embodiment, the halide may be chloride. In a further embodiment, the halide may be bromide. In an even further embodiment, the halide may be iodide. Such halide may be dictated by the use of the intercalation within the alumina.

In one embodiment, prior to eluting, a pre-eluting step may be conducted. For instance, such step may include providing an alkali metal and/or alkali earth metal solution to the lithium-selective sorbent. Such pre-eluting step may allow for removal of the source brine from the lithium-selective sorbent. Without intending to be limited, this may also assist in reducing or minimizing the impurities present in the eluate and recovered brine.

The solution may include a halide of such metal. The halide may be fluoride, chloride, bromide, or iodide. In one embodiment, the halide may be fluoride. In another embodiment, the halide may be chloride. In a further embodiment, the halide may be bromide. In an even further embodiment, the halide may be iodide. The alkali metal may include sodium, lithium, potassium, or a mixture thereof. In one embodiment, the alkali metal may include sodium. In another embodiment, the alkali metal may include potassium. In a further embodiment, the alkali metal may include lithium. The alkaline earth metal may include magnesium, calcium or a mixture thereof. In one embodiment, the alkaline earth metal may include magnesium. In another embodiment, the alkaline earth metal may include calcium.

In one particular embodiment, the pre-eluting may be conducted with an alkali metal, such as sodium, and a halide, such as chloride. In this regard, the pre-eluting may be conducted with a sodium chloride solution. In addition, the solution utilized in the pre-eluting step may be of a relatively high purity with a reduced concentration of impurities.

Regardless, the eluate may be a dilute lithium solution. In particular, the eluate may be a dilute lithium halide solution, such as a lithium chloride solution. In one embodiment, the concentration of lithium in the eluate may be substantially the same as the concentration of lithium in the brine. For instance, the concentration of lithium in the eluate may be within 1%, such as within 2%, such as within 3%, such as within 5% of the concentration of lithium in the brine. In another embodiment, the concentration of lithium in the eluate may be higher than the concentration of lithium in the brine. For instance, the concentration may be greater than 5%, such as 6% or more, such as 7% or more, such as 8% or more, such as 10% or more, such as 15% or more, such as 20% or more, such as 25% or more, such as 30% or more, such as 35% or more, such as 40% or more, such as 45% or more, such as 50% or more of the concentration of lithium in the brine. In one embodiment, the concentration may be 500% or less, such as 450% or less, such as 400% or less, such as 350% or less, such as 300% or less, such as 250% or less, such as 200% or less, such as 180% or less, such as 160% or less, such as 140% or less, such as 120% or less, such as 100% or less, such as 90% or less, such as 80% or less, such as 70% or less, such as 60% or less, such as 50% or less, such as 40% or less the concentration of lithium in the brine.

Regardless of the concentration of the lithium, the concentration of any other metal (e.g., alkali metal, alkaline earth metal, transition metal) impurities within the eluate may be less than the concentration of such impurities within the brine. In particular, the concentration may be reduced by 10% or more, such as 20% or more, such as 30% or more, such as 40% or more, such as 50% or more, such as 60% or more, such as 65% or more, such as 70% or more, such as 75% or more, such as 80% or more, such as 85% or more, such as 90% or more, such as 92% or more, such as 94% or more, such as 95% or more, such as 96% or more, such as 97% or more, such as 98% or more, such as 99% or more, such as 99.5% or more, such as 99.9% or more. In this regard, the use of the lithium-selective sorbent may allow for a relatively high separation efficiency thereby minimizing or reducing the concentration of impurities in the eluate and resulting covered lithium. In other words, the ratio of the concentration of lithium ions to other metal ions not including lithium in the eluate may be greater than the ratio of the concentrated lithium ions to other metal ions not including lithium in the brine.

This step with the lithium-selective sorbent may provide a relatively high lithium extraction efficiency and/or separation efficiency. For instance, this may have a certain lithium extraction efficiency. For instance, this efficiency may be 80% or more, such as 85% or more, such as 90% or more, such as 93% or more, such as 95% or more, such as 98% or more, such as 99% or more, such as 99.5% or more. Similarly, this may have a certain separation efficiency, based on monovalent (e.g., sodium) and other multivalent ions (e.g., calcium and/or magnesium). For instance, this efficiency may be 80% or more, such as 85% or more, such as 90% or more, such as 93% or more, such as 95% or more, such as 98% or more, such as 99% or more, such as 99.5% or more. Such aforementioned separation efficiency may refer to all of the combined ions in one embodiment. In another embodiment, such aforementioned separation efficiency may refer to any single ion, such as sodium or calcium or magnesium.

Even though the eluate may include a reduced concentration of impurities, the eluate may still nonetheless include some impurities. These purities may include monovalent impurities, divalent impurities, trivalent impurities, or a mixture thereof. In one embodiment, the impurities include monovalent impurities. In another embodiment, the impurities include trivalent impurities. In a further embodiment, the impurities include at least divalent impurities. For instance, these divalent impurities may include calcium and/or magnesium.

In order to remove such impurities, the eluate may be provided to an ion exchange resin. In this regard, the process disclosed herein may include a step of providing the eluate to an ion exchange resin. The ion exchange resin may be a weak acid cation exchange resin in one embodiment. In another embodiment, the ion exchange resin may be a strong acid cation exchange resin. The strong acid cation exchange resin may be a gel type cation exchange resin. For instance, the resin may be a styrene, divinylbenzene resin. One example of a strong acid cation exchange resin may be a sulfonic acid cation exchange resin. By utilizing such an ion exchange resin, the eluate may be softened by the reduction of impurities, in particular divalent impurities. For instance, such ions or impurities, in particular multi-valent ions or impurities, may be exchanged for other ions, such as sodium ions. Thereby, providing the eluate to the ion exchange resin may result in a softened lithium solution. Again, such lithium may be a lithium halide, in particular lithium chloride, as mentioned above.

Using the ion exchange resin, the concentration of multi-valent ions, in particular divalent ions, may be reduced compared to the concentration of such ions in the eluate. In particular, the concentration may be reduced by 10% or more, such as 20% or more, such as 30% or more, such as 40% or more, such as 50% or more, such as 60% or more, such as 65% or more, such as 70% or more, such as 75% or more, such as 80% or more, such as 85% or more, such as 90% or more, such as 92% or more, such as 94% or more, such as 95% or more, such as 96% or more, such as 97% or more, such as 98% or more, such as 99% or more, such as 99.5% or more, such as 99.9% or more.

In one embodiment, the softened lithium solution may contain multi-valent metals, in particular divalent metals, in an amount of 500 mg/L or less, such as 450 mg/L or less, such as 400 mg/L or less, such as 350 mg/L or less, such as 300 mg/L or less, such as 250 mg/L or less, such as 200 mg/L or less, such as 180 mg/L or less, such as 160 mg/L or less, such as 140 mg/L or less, such as 120 mg/L or less, such as 100 mg/L or less, such as 90 mg/L or less, such as 80 mg/L or less, such as 70 mg/L or less, such as 60 mg/L or less, such as 50 mg/L or less, such as 40 mg/L or less, such as 30 mg/L or less, such as 25 mg/L or less, such as 20 mg/L or less, such as 15 mg/L or less, such as 10 mg/L or less, such as 5 mg/L or less. Depending on the regenerant solution, in particular the purity of such solution, as mentioned below that is utilized in regenerating the ion exchange resin, the concentration may be relatively low.

In this regard, the concentration of such multi-valent ions in the softened lithium solution may be less than the concentration of such ions in the eluate. Similarly, the ratio of the concentration of lithium ions to other metal ions not including lithium in the softened lithium solution may be greater than the ratio of the concentration of lithium to other metal ions not including lithium in the eluate. Furthermore, the ratio of the concentration of lithium ions to other multi-valent, in particular divalent, metal ions not including lithium in the softened lithium solution may be greater than the ratio of the concentration of lithium to other multi-valent, in particular divalent, metal ions not including lithium in the eluate.

Once the eluate has been softened, the softened lithium solution may be provided to a subsequent ion exchange for further purification. For instance, such subsequent ion exchange may include a chelating ion exchange and/or a weak acid ion exchange. This may allow for an even higher purity lithium.

Once the eluate has been provided to the ion exchange resin and been softened, the ion exchange resin may be regenerated using various regenerants depending on the nature and chemistry of the resin utilized in the ion exchange resin. As an example, the regenerant solution may be an alkali metal halide solution, such as those alkali metals and halides mentioned herein and in particular a sodium chloride solution. In addition, such solution may be of a high purity. By high purity, in one embodiment, it may refer to a solution including a relatively low concentration of multi-valent ions, in particular divalent ions. In addition, it should be understood that the quantity of regenerant required is several times the stoichiometric dosage, based upon the divalent metals removed. In this regard, the regenerant brine use to regenerate the ion exchange resin may contain a total hardness of less than 500 mg/L, such as less than 450 mg/L, such as less than 400 mg/L, such as less than 350 mg/L, such as less than 300 mg/L, such as less than 250 mg/L (e.g., as CaCO₃).

By providing such a regenerant solution to the ion exchange resin after the eluting step, the ions may be exchanged within the ion exchange resin to provide a spent regenerant solution including multi-valent metal ions. The concentration of the multi-valent metal ions in the spent regenerant solution may be higher than the concentration of such ions in the regenerant solution.

The concentration of lithium in the softened lithium solution from the ion exchange resin may be low. For instance, such solution may be a dilute solution. In this regard, the concentration of lithium may be 0.001 g/L or more, such as 0.005 g/L or more, such as 0.01 g/L or more, such as 0.02 g/L or more, such as 0.05 g/L or more, such as 0.08 g/L or more, such as 0.1 g/L or more, such as 0.15 g/L or more, such as 0.2 g/L or more, such as 0.25 g/L or more, such as 0.3 g/L or more, such as 0.4 g/L or more, such as 0.5 g/L or more, such as 0.8 g/L or more, such as 1 g/L or more, such as 1.2 g/L or more, such as 1.4 g/L or more, such as 1.5 g/L or more, such as 2 g/L or more, such as 5 g/L or more. The concentration may be 100 g/L or less, such as 80 g/L or less, such as 60 g/L or less, such as 40 g/L or less, such as 20 g/L or less, such as 10 g/L or less, such as 8 g/L or less, such as 6 g/L or less, such as 5 g/L or less, such as 4 g/L or less, such as 3.5 g/L or less, such as 3 g/L or less, such as 2.8 g/L or less, such as 2.6 g/L or less, such as 2.4 g/L or less, such as 2.2 g/L or less, such as 2 g/L or less, such as 1.8 g/L or less, such as 1.6 g/L or less, such as 1.4 g/L or less, such as 1.2 g/L or less, such as 1 g/L or less, such as 0.9 g/L or less, such as 0.8 g/L or less, such as 0.7 g/L or less, such as 0.6 g/L or less. As a result, in one embodiment, the softened lithium solution may be concentrated.

In this regard, the process may include a concentrating step. For instance, when utilizing an ion exchange resin or softening step, the process may include a step of concentrating the softened lithium solution. In one embodiment, the process may include a step of concentrating the eluate. Regardless of the solution, the concentrating step and means may be similar. For instance, such concentrating may be done using various means known in the art. These means may include evaporating, reverse osmosis, or a combination thereof. However, it should be understood that other means of concentrating may also be utilized in accordance with the disclosure.

In one embodiment, such concentrating may be done via evaporation. For example, this may be conducted using heat and/or reduced pressure to remove any liquid, such as water, and to increase the concentration of the lithium within the solution.

In one embodiment, such concentrating may be done using reverse osmosis. Various methods of reverse osmosis may be used. For instance, the reverse osmosis may be a high pressure, in particular an ultra-high pressure, reverse osmosis. In this regard, the reverse osmosis may be conducted at pressures up to 1800 psi. In an embodiment, the reverse osmosis may be a novel process referred to as osmotically assisted reverse osmosis. Such reverse osmosis process may require a lower pressure and/or less energy compared to high pressure, in particular ultra-high pressure, reverse osmosis.

In a further embodiment, such concentrating may be conducted using a combination of methods for concentration. For instance, the concentrating may be done by via a first concentrating step and a second concentrating step. In one embodiment, the method of concentrating utilized in the first concentrating step may be different than the method of concentrating utilized in the second concentrating step. In this regard, in one embodiment, the first concentrating step may utilize reverse osmosis while the second concentrating step may utilize evaporation.

Without intending to be limited, such combination may allow for an efficient and less energy-intensive concentrating step. For instance, a relatively high amount of liquid, in particular water, may be removed utilized reverse osmosis. For instance, reverse osmosis may be utilized to remove 50% or more, such as 60% or more, such as 70% or more, such as 80% or more, such as 85% or more, such as 90% or more, such as 95% or more, such as 98% or more, such as 99% or more of the liquid, such as water, present. In one embodiment, the aforementioned percentage may refer to weight percentage. In another embodiment, such aforementioned percentage may refer to a volume percentage. Regardless, with a high percentage removal, the amount of liquid, such as water, required for removal using other means, such as evaporation, will be relatively low. In this regard, the energy required for such removal would be reduced compared to a process that did not utilize such a first concentrating step, such as reverse osmosis, that is generally less energy intensive.

The concentrating step may result in a concentrated lithium solution having an increased concentration of lithium compared to the softened lithium solution and/or the eluate. For instance, the concentration may be more than 100 mg/L, such as 150 mg/L or more, such as 200 mg/L or more, such as 250 mg/L or more, such as 500 mg/L or more, such as 1,000 mg/L or more, such as 2,000 mg/L or more, such as 3,000 mg/L or more, such as 5,000 mg/L or more, such as 8,000 mg/L or more, such as 10,000 mg/L or more. In one embodiment, the aforementioned concentrations refer to the concentration of the lithium after the concentrating step. In another embodiment, the aforementioned concentrations refer to the concentration of the lithium after the first concentrating step wherein the concentration is in regard to the first concentrated lithium solution prior to the second concentrating step. Regardless, the concentration of lithium in such first concentrated lithium solution may be greater than the concentration of the lithium compared to the softened lithium solution and/or the eluate.

The concentrated lithium solution from the concentrating step contains a relatively high concentration of lithium, presented as a lithium halide in particular lithium chloride. Furthermore, such solution may contain a relatively low concentration of impurities, in particular multi-valent metal ions and in particular divalent metal ions.

In addition, such solution may also contain a relatively low concentration of monovalent metal ions, in particular sodium ions. For example, such reduction in sodium may be due to the removal of such ions via reverse osmosis. For instance, 50% or more, such as 60% or more, such as 70% or more, such as 80% or more, such as 85% or more, such as 90% or more, such as 92% or more, such as 94% or more, such as 95% or more, such as 96% or more, such as 97% or more, such as 98% or more, such as 99% or more of the monovalent ions, such as sodium ions, may be removed from the softened lithium solution to the concentrated lithium solution.

In this regard, the concentrated lithium solution may contain metal ions, other than lithium ions, in an amount of 500 mg/L or less, such as 450 mg/L or less, such as 400 mg/L or less, such as 350 mg/L or less, such as 300 mg/L or less, such as 250 mg/L or less, such as 200 mg/L or less, such as 180 mg/L or less, such as 160 mg/L or less, such as 140 mg/L or less, such as 120 mg/L or less, such as 100 mg/L or less, such as 90 mg/L or less, such as 80 mg/L or less, such as 70 mg/L or less, such as 60 mg/L or less, such as 50 mg/L or less, such as 40 mg/L or less, such as 30 mg/L or less, such as 25 mg/L or less, such as 20 mg/L or less, such as 15 mg/L or less, such as 10 mg/L or less, such as 5 mg/L or less, such as 4 mg/L or less, such as 3 mg/L or less, such as 2 mg/L or less, such as 1 mg/L or less. In one embodiment, the aforementioned may refer to total metal ions other than lithium ions. In another embodiment, the aforementioned may refer to multi-valent metal ions other than lithium ions. In a further embodiment, the aforementioned may refer to monovalent metal ions, such as sodium ions.

In addition, other process steps may also assist with improving the efficiency and making the process more environmentally friendly. For instance, through reverse osmosis, the process may result in a permeate stream. Similarly, through evaporation, the process may result in a condensate stream. In one embodiment, the respective stream(s) may be reused for elution of the lithium-selective sorbent. In this regard, in one embodiment, the process may include a step of providing the respective stream(s) from the concentrating step to the lithium-selective sorbent for elution.

In addition, in one embodiment, as the lithium is being concentrated in the concentrating step, other ions, such as monovalent ions and in particular sodium, may also be concentrated. For instance, the concentrated lithium solution may include such monovalent ions and in particular sodium. Such solution may be further concentrated. For instance, such monovalent ions, such as sodium, in particular in the form of sodium halide such as sodium chloride, may be crystallized during such subsequent concentrating step. In general, without intending to be limited by theory, this increase in concentration of monovalent ions such as sodium, such as sodium chloride, may be due to the chloride “common-ion” effect. In this regard, such concentrating may result in monovalent ions and in particular sodium, crystallizing out of solution in the form of a salt. For example, the salt may be a halide, dictated by the halide utilized herein.

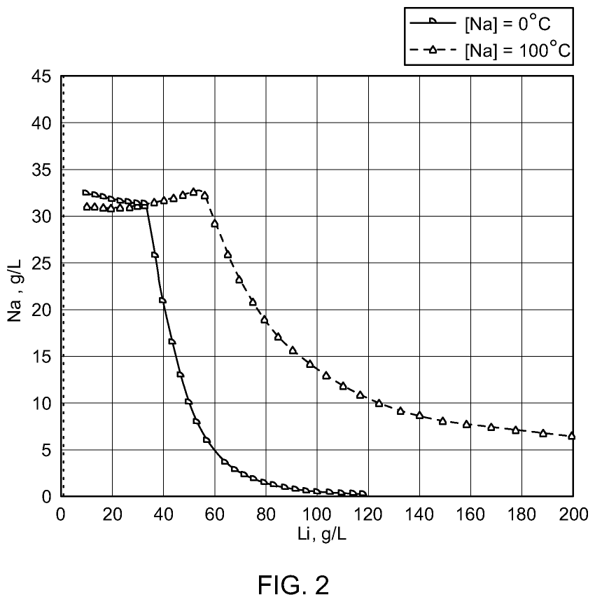

As just one example, FIG. 2 generally shows the solubility of NaCl (expressed as Na) as it is concentrated by evaporation from an initial concentration (post-revers osmosis) of [Li]=10 g/L and [Na]=32 g/L. This data was generated by electrolyte simulation software from OLI Systems, Inc. The lithium can be concentrated up to at least 118 g/L with no crystallization of lithium chloride occurring at 100° C. If the evaporator concentrate is cooled to 0° C., the solubility of the NaCl is reduced to less than [Na]=1 g/L while no lithium chloride is crystallized.

In this regard, the process disclosed herein may include a step of further concentrating the concentrated lithium solution. Similarly, the process may include a step of crystallizing an alkali metal halide, such as sodium chloride, from the concentrated lithium solution due to the concentrating step, such as reverse osmosis and/or evaporation. For instance, as indicated above, such concentrating may be conducted due to the “common-ion” effect mentioned above. The concentration may be 1,000 mg/L or more, such as 2,000 mg/L or more, such as 3,000 mg/L or more, such as 5,000 mg/L or more, such as 10,000 mg/L or more, such as 15,000 mg/L or more, such as 20,000 mg/L or more, such as 25,000 mg/L or more, such as 30,000 mg/L or more, such as 32,000 mg/L or more, such as 35,000 mg/L or more.

Once crystallized, it may be removed from the concentrated lithium solution using conventional solid/liquid separation processes. These may include centrifuge, filter, or a combination thereof. In one embodiment, such process may include centrifuge. In another embodiment, such process may include a filter, such as a vacuum filter.

Furthermore, such crystallization may result in crystallized product, such as alkali metal halide product. Such product may be a relatively high purity product. For instance, the purity may be 90% or more, such as 92% or more, such as 95% or more, such as 98% or more, such as 99% or more. In this regard, such product may contain a relatively low concentration or amount of multi-valent metals such as divalent metals. As a result, the product obtained through the concentrated solution may be recycled. In particular, it may be recycled to regenerate the ion exchange resin, in particular the strong acid ion exchange resin. In this regard, the process may include a step of recycling the crystallized product to the ion exchange resin, in particular as the regenerant. In this regard, because it will be crystallized into a solid, it may be combined with water to form a regenerant solution prior to providing to the ion exchange resin. Typically, the quantity of sodium chloride produced may be sufficient in quantity to satisfy the regeneration requirements.

The spent regenerant solution exiting the ion exchange resin may include certain metal ions. For instance, it may contain some residual sodium, although the concentration may be less than the regenerant solution as the sodium may be utilized to regenerate the ion exchange resin. In addition, the spent regenerant solution may include lithium ions. It may also include other ions, such as divalent ions including calcium and/or magnesium. The spent regeneration solution may be combined with the brine containing lithium which be provided to the lithium-selective sorbent for processing and to recover any lithium in such solution.

Furthermore, the feed eluate to the ion exchange resin may already include monovalent metal ions, such as sodium ions. As a result, in one embodiment, it may not be necessary to provide fresh water, such as water having a relatively high purity, to the ion exchange resin prior to providing the regenerant solution to the ion exchange resin for regenerating the resin. In this regard, any entrained eluate still remaining in the ion exchange resin may be combined with the regenerant solution and combined with the brine for processing via the lithium-selective sorbent. For similar reasons, it may not be necessary to use water to rinse the spent regenerant solution from the ion exchange resin prior to introduction of the eluate. However, in one embodiment, a relatively low amount or volume of water may be utilized to displace any spent regenerant solution from the ion exchange resin prior to providing the eluate to the ion exchange resin. In this regard, such volume may be 2 bed volumes or less, such as 1.5 bed volumes or less, such as 1 bed volume or less, such as 0.8 bed volumes or less. This water may be utilized to dissolve any sodium chloride, in particular solid sodium chloride, present used for the regeneration of the ion exchange resin.

Furthermore, the concentrating step as disclosed herein results in a concentrated lithium solution. This solution can then undergo a liquid/solid separation to yield an alkali metal halide as mentioned herein. Using the separation to remove such solid, the final product may be a concentrated lithium product, such as a lithium halide product. In particular, the halide may be dictated by the halide used in the process. In this case, in one embodiment, the halide may be a chloride thereby resulting in a concentrated lithium chloride product. However, in the instance a separation step is not utilized, it should be understood that the concentrated lithium solution from the concentrating step may be considered the lithium chloride product.

While the above mentions various steps, it should be understood that these steps may be used in any combination. For instance, the process may include steps of providing a brine to a lithium-selective sorbent, providing the eluate to an ion exchange resin (or exchanging any multi-valent ions other than lithium in the eluate for monovalent ions) to form a softened lithium solution, and crystallizing the monovalent ions. Such process can result in a crystallized product and a concentrated lithium product.

In one embodiment, the process may include a step of providing a brine to a lithium-selective sorbent, providing the eluate to an ion exchange resin (or exchanging any multi-valent ions other than lithium in the eluate for monovalent ions) to form a softened lithium solution, concentrating the softened lithium solution, and crystallizing the monovalent ions in the softened lithium solution. Such process can result in a crystallized product and a concentrated lithium product.

While the above are simply two examples, it should be understood that other combinations may also be utilized. In addition, within each of these examples it should be understood that other steps as disclosed herein may also be utilized. For instance, regarding the concentrating of the softened lithium solution, it should be understood that this may be done via reverse osmosis and/or evaporation. Similarly, any steps referring to recycling or reusing permeate streams, condensate streams, crystallized product for regenerant solutions, and/or spent regenerant solutions may also be combined as necessary within any embodiment as disclosed herein.

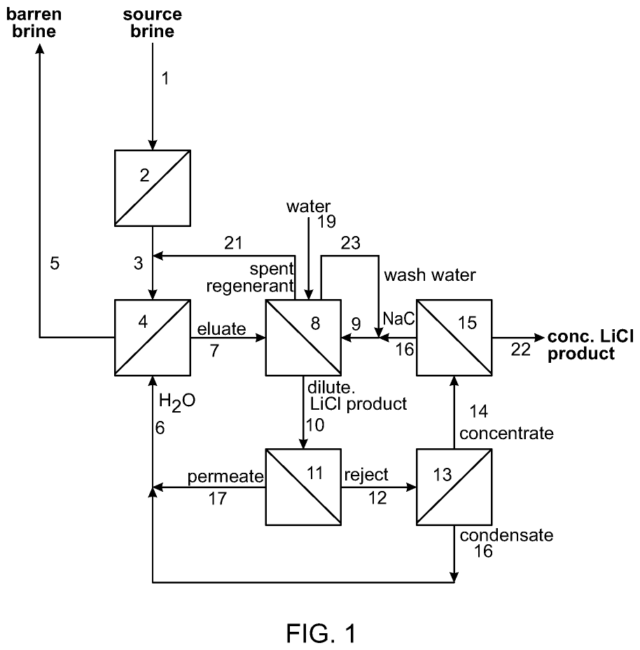

One general process of the disclosure is illustrated in FIG. 1. For instance, a brine containing lithium (1) may be pre-treated (2) as necessary. Thereafter, the pre-treated brine (3) may be provided to a lithium-selective sorbent (4). This will result in a barren brine (5) and an eluate (7). The eluate (7) is provided to an ion exchange resin (8) to provide a softened lithium solution (10), which is provided to a reverse osmosis system (11). This reverse osmosis system (11) yields a permeate stream (17) which can be provided back to the lithium-selective sorbent (4). The reverse osmosis system (11) also yields a reject stream or first concentrated solution (12). This stream or solution (12) is provided to an evaporation system (13). The evaporation system (13) yields a condensate stream (18) which can be combined with the permeate stream (17) and provided back to the lithium-selective sorbent (4). The evaporation system (13) also yields a concentrated lithium solution (14) which can b provided to a solid/liquid separator (15). The solid (16) from the separator is combined with water (23) to form a regenerant solution (9) that can be fed to the ion exchange resin (8). The spent regenerant solution (21) can be combined with the brine (1) or pre-treated brine (3) prior to introduction to the lithium-selective sorbent (4). In addition, water (19) may be provided to the ion exchange resin (8) for displacing any regenerant remaining in the bed. Finally, the solid/liquid separator (15) will yield a concentrated lithium product.

It should be noted that one or more of the elements depicted in FIG. 1 can be omitted in certain embodiments. For example, the pre-treatment process 2 may not be desirable in certain situations. Other process steps shown in FIG. 1 may also be removed in certain applications.

The obtained lithium product may be used for various applications as known in the art. For instance, the lithium may be processed to produce materials such as lithium carbonate or lithium hydroxide using known processes for various applications. In particular, lithium is used in energy storage devices for electrical vehicles. With the increase in electrical vehicles, the need for lithium will only be increased.

### Example 1

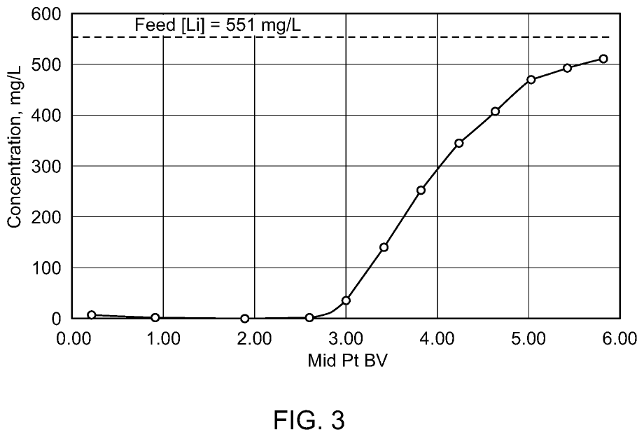

A source brine (brine #1) collected from a salar in Argentina with the composition shown in Table 1 was pumped up-flow through a 4-inch diameter by a 48-inch-high bed of Sunresin LA10 resin with a bed volume of 10 litres, at a flow rate of approximately 2.10 litres per minute. The concentration of lithium in the effluent (i.e., raffinate) is shown in FIG. 3 as a function of the volume collected. This shows that the lithium concentration was reduced from [Li]=551 mg/L in the feed to less than 1 mg/L in the effluent until breakthrough occurred at 2.60 bed volumes (BV).

TABLE 1
Source Brine Composition

| [Li] | [Na] | [K] | [Ca] | [Mg] | [SO₄] |
|---|---|---|---|---|---|
| mg/L | mg/L | mg/L | mg/L | mg/L | mg/L |
| 551 | 118,781 | 4,171 | 329 | 1,230 | 14,768 |

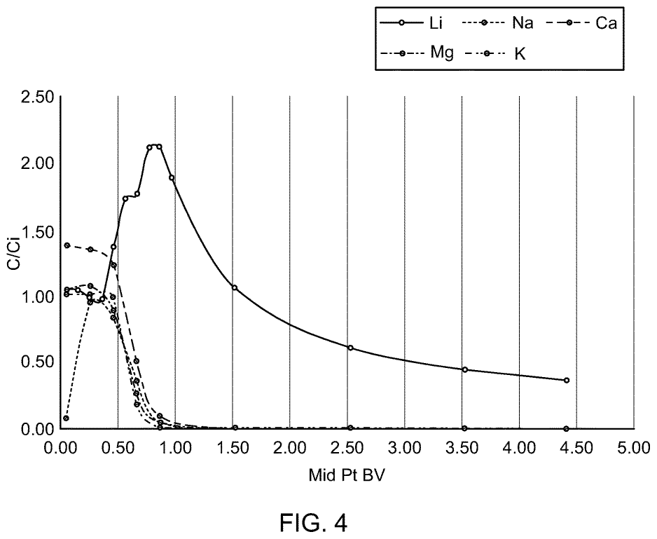

In addition, 0.2 bed volumes of approximately 100 g/L solution of sodium chloride was pumped downflow through the column to partially displace the feed brine from the bed, followed by 4.8 bed volumes of a first eluent at a flow rate of approximately 2.2 L/min. This first eluent was water containing 97 mg/L of lithium, as it had been produced in a second elution step in the previous cycle. This was followed by an additional 5 bed volumes of pure water in a second elution step. The effluent from the second elution step was retained for use in a subsequent cycle as the first eluent. The elution profile following the initial 0.2 bed volumes of NaCl to the end of the first elution step is shown in FIG. 4. This shows that after 0.9 bed volumes and the displacement of the entrained void of feed solution and NaCl, the lithium chloride that is produced by the elution is largely devoid of sodium, magnesium and calcium contamination. Note that the concentrations shown are normalized against the feed concentration.

Three cycles were operated under operating conditions based on the loading and elution profiles shown in FIGS. 3 and 4. A composite of the initial 2.8 bed volumes of raffinate during the loading and a composite of the 0.6-4 bed volumes fraction of eluate were collected. The composition of these streams is shown in Table 2. The raffinate collected from 2.8 to 4.8 bed volumes was recycled and combined with the source brine and re-processed as feed. These results show approximately >99% extraction of lithium from the feed brine. The lithium chloride recovered from elution had a lithium concentration that was 76% of the initial feed brine, however greater than 99% of the sodium, 98% of the magnesium and 98% of the calcium were removed, when the lithium concentration was taken into account.

TABLE 1
Composite Stream Compositions

| | [Li] | [Na] | [Ca] | [Mg] |
|---|---|---|---|---|
| | mg/L | mg/L | mg/L | mg/L |
| Source brine | 602 | 108,726 | 380 | 1,424 |
| Raffinate | 1.02 | Not determined | Not determined | 1,214 |
| Eluate | 456 | 591 | 4.47 | 17.5 |

### Example 2

The experiment of Example 1 was repeated, except that the volume of eluent was reduced from 4 bed volumes to 3 bed volumes for each eluent step. The first 3 bed volumes of barren brine raffinate were collected and the next 2 bed volumes of the raffinate were recycled back to the feed tank for subsequent processing. The composition of the composite raffinate and composite eluate are shown in Table 3. These results show greater than 99% lithium extraction efficiency and greater than 98% separation efficiency of calcium, sodium, and magnesium in the eluate. The lithium concentration in the eluate was 82% of the feed concentration.

TABLE 2
Composite Stream Compositions

| | [Li] | [Na] | [Ca] | [Mg] |
|---|---|---|---|---|
| | mg/L | mg/L | mg/L | mg/L |
| Source brine | 602 | 108,736 | 380 | 1,424 |
| Raffinate | 1.11 | 89,845 | 386 | 1,225 |
| Eluate | 494 | 1,221 | 9.02 | 27.5 |

### Example 3

The eluate was collected over several cycles under the conditions shown in Example 2. The total dissolved solids of the solution was 6133 mg/L (as CaCO₃). This was passed through a 1-inch diameter by 48-inch bed of Lewatit MDS200 strong acid cation exchange resin at a flow rate of 30 bed volumes/h. The resin had been regenerated with a brine containing [NaCl]=150 g/L, [Ca]=1.91 mg/L and [Mg]=<0.2 mg/L, representing a total hardness of 4.76 mg/L. to put it into the sodium form. No calcium or magnesium were detected in the effluent in the 80 liters of effluent that was collected, indicating the concentration was less than 0.2 mg/L of each.

### Example 4

The purified lithium chloride solution produced in Example 3 was concentrated by seawater reverse osmosis at a pressure of up to 1000 psi. The solution was continuously recirculated from a feed tank through the membrane module and back again to the feed tank. The permeate was collected and this was continued until the permeate flow rate dropped to almost zero. The composition of the initial feed and final concentrate solutions is shown in Table 4. The lithium was concentrated by a factor of approximately 9 times.

TABLE 4
Reverse Osmosis Concentration Results

| | [Li] | [Na] | [K] | [Ca] | [Mg] |
|---|---|---|---|---|---|
| Stream | mg/L | mg/L | mg/L | mg/L | mg/L |
| RO feed | 508 | 2236 | 22 | 0 | 0 |
| RO concentrate | 4660 | 16460 | 202 | 4.46 | 0.53 |

### Example 5

The concentrated lithium chloride solution from the reverse osmosis test in Example 5 was concentrated by boiling in a beaker over a hot plate at atmospheric pressure. As the solution was concentrated, sodium chloride crystallized out of solution and was filtered. The final concentrate was cooled to 3° C., allowing additional sodium chloride to crystallize out of solution. The solid sodium chloride was filtered from the liquid. The composition of the original solution and the final concentrated solution is shown in Table 5. This shows that the evaporation/crystallization removed 99.8% of the sodium. If the solution had been further evaporated, additional sodium would have been removed. Compared to the original source brine, greater than 99.9% of the sodium, calcium and magnesium impurities were removed in the final evaporator concentrate.

The NaCl crystals were assayed and found to contain 0.001% Ca and 0.00003% Mg. A [NaCl]=150 g/L regenerant solution would then contain [Ca]=18.8 mg/L and [Mg]=0.6 mg/L for a total hardness concentration of 62 mg/L. This would be suitable for regeneration of the strong acid cation exchange unit.

TABLE 5
Evaporation of Reverse Osmosis Concentrate

| | [Li] | [Na] | [Ca] | [Mg] | [Li]/ | [Li]/ | [Li]/ |
|---|---|---|---|---|---|---|---|
| | mg/L | mg/L | mg/L | mg/L | [Na] | [Ca] | [Mg] |
| Source Brine | 602 | 108,736 | 380 | 1,424 | 0.00553 | 1.53 | 0.423 |
| Evaporator Feed | 4,660 | 16,460 | 4.46 | 0.53 | 0.283 | 1045 | 8792 |
| Evaporator | 90,400 | 735 | 46 | 17 | 123 | 1965 | 5318 |
| Concentrate | | | | | | | |

These and other modifications and variations of the disclosure may be practiced by those of ordinary skill in the art, without departing from the spirit and scope of the disclosure. In addition, it should be understood that aspects of the various embodiments may be interchanged both in whole or in part. Furthermore, those of ordinary skill in the art will appreciate that the foregoing description is by way of example only, and is not intended to limit the disclosure so further described in such appended claims.

1. A process of recovering lithium from a brine containing lithium, the process comprising
providing the brine to a lithium-selective sorbent for adsorbing the lithium to the lithium-selective sorbent;
eluting the lithium from the lithium-selective sorbent to form an eluate containing the lithium and multi-valent ions;
exchanging the multi-valent ions in the eluate for monovalent ions to form a softened lithium solution using a strong acid cation exchange resin; and
crystallizing the monovalent ions to form a crystallized product and a concentrated lithium product,
further wherein the process includes a step of combining the crystallized product with water to form a regenerant solution and wherein the regenerant solution is provided to the strong acid cation exchange resin for regenerating the resin after the exchanging step.

2. The process of claim 1, wherein the process includes a step of concentrating the softened lithium solution prior to the crystallizing step.

3. The process of claim 2, wherein the concentrating is conducted using reverse osmosis to form a first concentrated solution.

4. The process of claim 3, wherein the process includes a step of concentrating the first concentrated solution by evaporating to form a concentrated solution.

5. The process of claim 2, wherein the concentrating is conducted using evaporating to form a concentrated solution.

6. The process of claim 2, wherein the concentrating step includes a first reverse osmosis step and a second evaporating step.

7. The process of claim 6, wherein the reverse osmosis yields a permeate stream provided to the lithium-selective sorbent.

8. The process of claim 7, wherein the evaporating step yields a condensate stream provided to the lithium-selective sorbent.

9. The process of claim 8, wherein the permeate stream and the condensate stream are combined.

10. The process of claim 1, wherein the strong acid cation exchange resin comprises a sulfonic acid cation exchange resin.

11. The process of claim 1, wherein the monovalent ions comprise sodium ions.

12. The process of claim 1, wherein the crystallized product comprises sodium chloride.

13. The process of claim 1, wherein a spent regenerant solution is provided to the lithium-selective sorbent.

14. The process of claim 1, wherein the spent regenerant solution is combined with the brine prior to providing to the lithium-selective sorbent.

15. (canceled)

16. (canceled)

17. (canceled)

18. The process of claim 1, wherein the lithium selective sorbent comprises hydrated alumina intercalated with a lithium halide salt.

19. (canceled)

20. The process of claim 1, wherein the lithium selective sorbent comprises an oxide of titanium.

21. The process of claim 1, wherein the lithium selective sorbent comprises metatitanic acid.

22. The process of claim 1, wherein the lithium selective sorbent comprises an oxide of niobium.

23. The process of claim 18, wherein the lithium selective sorbent comprises lithium niobate.

24. The process of claim 1, wherein the eluting is conducted with a dilute acid.
